(19) United States
(12) Patent Application Publication
(10) Pub. No.: US 2007/0202918 A1
(43) Pub. Date: Aug. 30, 2007

(54) Apparatus and method for testing and analyzing base station with smart antenna, and protocol structure

(76) Inventors: Sung-Moon Shin, Daejeon-city (KR); Seung-Chan Bang, Daejeon-city (KR)

Correspondence Address: MAYER, BROWN, ROWE & MAW LLP, 1909 K STREET, N.W., WASHINGTON, DC, 20006, US

(21) Appl. No.: 10/584,334

(22) PCT Filed: Dec. 22, 2004
(86) PCT No.: PCT/KR04/02437

§ 371 Date: Jan. 23, 2007

(30) Foreign Application Priority Data
Dec. 23, 2003 (KR) 10-2003-0095255
Mar. 9, 2004 (KR) 10-2004-0015784

(51) Int. Cl. H04M 1/00

(52) U.S. Cl. 455/562.1

(57) ABSTRACT

Disclosed is a downlink signal configuring method and device, and synchronization and cell search method and device using the same in a mobile communication system. A downlink frame has plural symbols into which pilot subcarriers are distributively arranged with respect to time and frequency axes. Initial symbol synchronization and initial frequency synchronization are estimated by using a position at which autocorrelation of a cyclic prefix of a downlink signal and a valid symbol of the downlink is maximized, and cell search and integer-times frequency synchronization are estimated by using pilot subcarriers included in the estimated symbol. Fine symbol synchronization, fine frequency synchronization, and downlink frame synchronization is estimated by using an estimated cell search result. Downlink frequency and time tracking is performed, cell tracking is performed by using a position set of pilot subcarriers inserted into the downlink frame, fine symbol synchronization tracking and fine frequency synchronization tracking are repeated by using the pilot subcarriers to perform the frequency and time tracking of the downlink frame.

### TECHNICAL FIELD

The present invention relates to an apparatus and method for testing and analyzing a base station with a smart antenna (SA), and a protocol structure for the same. More specifically, the present invention relates to an apparatus and method for testing and analyzing a base station with an SA in a WCDMA (Wideband CDMA) mobile communication system, and a protocol structure for the same.

### Background Art

Korean Patent Application No. 1995-17182 (filed on Jun. 23, 1995) discloses an invention under the title of “Related Apparatus for Performance Analysis of CDMA Mobile Communication System, Construction Method, and Analysis Method”, which provides an apparatus, a construction method, and an analysis method for analyzing wireless link-related performance such as bit energy-to-noise ratio, traffic frame quality, etc. as well as various statistic characteristics and system parameters for a network in a CDMA mobile communication system providing a voice service only.

More specifically, the cited invention of Korean Patent Application No. 1995-17182, where a device for collecting performance-related data from the system, a message-collecting device, and a device for analyzing these data and messages are independently provided, can be effectively applied to parameter optimization of the CDMA mobile communication system. However, the functions for data collection and analysis are implemented in independent devices, demanding troublesome work in performance analysis, and there is no test call function.

Another conventional technique is described in a paper under the title of development of the Test and Evaluation Systems for the CDMA Mobile System (ETRI Journal Vol. 19, 3^{rd} Edition, pages 281-318). This paper relates to an apparatus for performance analysis of a CDMA wireless communication system and an analysis method, and specifies an improvement of the cited patent, Korean Patent Application No. 1995-17182.

More specifically, according to the paper, a device for collecting wireless link performance data necessary for performance analysis is installed separately in both a mobile station and a base station to analyze the performance of both forward and backward links and also to optimize parameters necessary for installation of a CDMA mobile communication system. However, the use of the device separately installed in both the mobile station and the base station for implementation of data collection and analysis functions may accompany troublesome work in performance analysis.

Korean Patent Application No. 1999-54897 (filed on Dec. 3, 1999) discloses a patent under the title of “Apparatus and Method for Wireless Link Performance Analysis of CDMA Mobile Communication System”, which provides an apparatus and method for analyzing the wireless link performance of a next-generation CDMA mobile communication system that provides multimedia services as the MT-2000 mobile communication system does.

The apparatus for analyzing the wireless link performance of a next-generation CDMA mobile communication system providing multimedia services includes a test call generator for generating service-specific test calls and providing the generated test calls to a base station; a network interface for receiving data related to the wireless link performance from the base station; and a performance analyzer for analyzing the performance of the CDMA mobile communication system using the data related to the wireless link performance and displaying the analysis result on a screen.

More specifically, the invention of Korean Patent Application No. 1999-54897, which is for effectively performing a wireless link performance analysis required in the performance test of a next-generation CDMA mobile communication system providing multimedia services, includes a performance-related data collection function, a data analysis function, and a real-time graph display function for the analysis result, and generates test calls by service type.

In the cited patent that integrates data collection and analysis functions with a function of generating test calls by service type, a series of test and evaluation procedures such as a service-specific test call generating step, a service-specific performance analysis step for CDMA mobile communication systems, and a parameter optimization step can be performed consistently, but the calls are not controlled, requiring a connection to the controller only with a burden of an excessive test cost.

The next-generation mobile communication system including the MT-2000 system is expected to provide mass multimedia services relating to video and Internet as well as voice, and accordingly demands a great enhancement of the wireless link performance including a wireless system capacity.

In addition, the SA technique is a next-generation capacity enhancement technology for simultaneously providing high-speed mobile communication services for many more mobile subscribers than the existing systems at a limited frequency bandwidth. However, such an SA technique requires a device for effectively testing the function and the performance of the system in both laboratory and field settings.

### DISCLOSURE OF INVENTION

Technical Problem

It is an advantage of the present invention to provide an apparatus and method for testing and analyzing a base station having an SA, and a protocol structure for the same, that is for effectively testing the function and the performance of a WCMA base station during installation and operation of the WCDMA system as well as system development by generating mass multimedia test calls to the WCDMA subscriber stations.

Technical Solution

In one aspect of the present invention, there is provided an apparatus for testing and analyzing a base station having a smart antenna that includes: a test analyzer body for performing management of a test call including channel establishment/release of the base station, connecting to the base station to generate mass mobile communication multimedia test calls, and measuring and analyzing an operational state of the system including service-specific functions and performance of the system; and a test analyzer interface for transmitting/receiving a protocol signal message, traffic, and performance data to/from the test analyzer body.

The test analyzer body includes: a user interface for generating a test call so as to enable a direct connection to the base station for monitoring the performance of the system; a test call processor for selecting a protocol corresponding to the test call, analyzing a signal message for the protocol to monitor a call setup procedure, processing the test call to analyze traffic, and monitoring the quality of the traffic according to the analysis result of the traffic; a protocol processor for generating a signal message used for the selected protocol; a data processor for analyzing and processing the performance data of the test call processor; and a network interface for communicating with the test analyzer interface to transmit/receive the protocol signal message, the traffic, and a performance message.

The test call processor includes: a test call analyzer for selecting a corresponding protocol according to the test call; a traffic analyzer for reporting the protocol signal message to the test call analyzer to monitor the call setup procedure, or reporting the analysis result of the traffic to the test call analyzer to monitor the quality of the traffic; and a signal message database for storing the signal message in order.

The data processor includes: a data analyzer for analyzing the performance data of the test call processor; and a performance database for storing an analysis result of the data analyzer.

The test call includes a voice, video, or Internet multimedia call. The test call communicates with a mobile station according to a corresponding protocol.

The protocol processor establishes a channel to a mobile station using a message stored in a signal message database according to the corresponding protocol.

When a channel to the mobile station is established, the protocol processor reports the result to the network interface and a traffic analyzer of the test call processor and transmits/receives the corresponding traffic to/from the mobile station.

Preferably, the analysis result of the traffic includes an analysis result of a frame error rate, or a propagation delay.

Preferably, the analysis result of the data processor includes an analysis result of a modulation/demodulation state, or an operational performance of the base station.

The data stored in the performance database are reported to the user interface by a request of an operator, enabling the operator to monitor the performance of the mobile communication system.

In another aspect of the present invention, there is provided a method for testing and analyzing a base station having a smart antenna, that includes: (a) generating a test call so as to enable an operator to directly connect to the base station and monitor performance of the system; (b) selecting a protocol corresponding to a test call input by the operator; (c) generating a signal message used for the selected protocol; (d) monitoring a call setup procedure according to the protocol signal message, or processing the test call to analyze traffic; and (e) testing a function, performance, and an operational state of the base station according to the analysis result of the traffic, and analyzing performance data according to the test result.

The method further includes: transmitting the protocol signal message, the traffic, and the performance data.

The method further includes storing the signal message and the performance data in a database.

Here, the test call includes a voice, video, or Internet multimedia call. The test call communicates with a mobile station according to a corresponding protocol.

Here, an operational state parameter tested in the step (e) is selected from a group consisting of a traffic frame quality, a bit energy-to-noise ratio, operational performance of the base station system, and a mobile station location.

In further another aspect of the present invention, there is provided a communication protocol structure of an apparatus for test analysis of a base station that includes: (a) an application layer for requesting a call control service to control a test call generated from a test analyzer body; (b) a call control (CC) layer for performing the call control service and then requesting a mobility management service; (c) a mobility management (MM) layer for performing the mobility management service and then requesting a radio resource control service; (d) a radio resource control (RRC) layer for performing the radio resource control service and then requesting a radio link control service; (e) a radio link control (RLC) layer for performing the radio link control service and then requesting a medium access control service; (f) a medium access control (MAC) layer for performing the medium access control service and then requesting a frame protocol service; (g) a frame protocol (FP) layer for performing the frame protocol service and then requesting an Ethernet service; and (h) an Ethernet layer for transferring a service request of the test analyzer body to a test analyzer interface.

The communication protocol structure further includes a codec layer for processing multimedia traffic.

The communication protocol structure further includes: a node-B application protocol (NBAP) layer for transmission of performance data between the test analyzer and the base station.

In further another aspect of the present invention, a communication protocol structure of an apparatus for test analysis of a base station, which is a communication protocol structure of an apparatus for test analysis of a base station having a smart antenna in a WCDMA mobile communication system, comprises: (a) an application layer for requesting a call control service to control a test call generated from a test analyzer body; (b) a call control (CC) layer for performing the call control service and then requesting a mobility management service; (c) a mobility management (MM) layer for performing the mobility management service and then requesting a radio re source control service; (d) a radio resource control (RRC) layer for performing the radio resource control service and then requesting a radio link control service; (e) a radio link control (RLC) layer for performing the radio link control service and then requesting a medium access control service; (f) a medium access control (MAC) layer for performing the medium access control service and then requesting a frame protocol service; (g) a frame protocol (FP) layer for performing the frame protocol service and then requesting an Ethernet service; and (h) an Ethernet layer for transferring a service request of the test analyzer body to a test analyzer interface, wherein the test analyzer interface of the step (h) processes services of the Ethernet layer and the frame protocol layer and transfers service requests of the application layer and the medium access control layer.

In still another aspect of the present invention, there is provided a method for using a communication protocol among a mobile station, a base station, and a test analyzer that includes: (a) transferring service requests from a plurality of protocol layers of a test analyzer body; (b) processing services of an Ethernet layer and a frame protocol layer among the plural protocol layers, and transferring service requests of an application layer or a medium access control layer; (c) carrying the service requests of the application layer or the medium access control layer transferred to the base station on an L1 (Layer 1) layer and transferring the carried service quests to the normal mobile station; and (d) processing the service from the normal mobile station in a reverse direction of processing the service requests among the layers of the test analyzer body.

Here, traffic communication between the test analyzer body and the normal mobile station is achieved through a codec layer for processing multimedia traffic.

Performance data transferred between the test analyzer body and the base station are transmitted to the test analyzer body via a NBAP layer.

For an effective test of the wireless link performance of the base station having a WCDMA smart antenna, the present invention causes the base station to generate mass multimedia test calls immediately and provides a service-specific wireless link performance for the operator, economically enhancing and guaranteeing the required performance of the system.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic of a WCDMA mobile communication system with an SA according to an embodiment of the present invention;

FIG. 2 is a schematic of a test analyzer for testing a base station with an SA according to an embodiment of the present invention; and

FIG. 3 illustrates a communication protocol structure of an apparatus for testing a base station with an SA according to an embodiment of the present invention.

### BEST MODE FOR CARRYING OUT THE INVENTION

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

Hereinafter, an apparatus and method for testing a base station with an SA, and a protocol structure for the same according to an embodiment of the present invention will be described in detail with reference to the accompanying drawings.

The base station with an SA is superior in system performance to a base station without any SA, and accordingly involves much more numerous types and a larger amount of data and parameters relating to the system function and performance. Hence, there is a demand for an environment for testing function and performance data in an economical and effective way.

According to an embodiment of the present invention, the function and the performance of a WCDMA SA base station providing multimedia services can be effectively tested and analyzed in both laboratory and field settings. In addition, a more precise and effective diagnosis can be made regarding the system function and performance, and also, the multimedia services can be provided for the subscriber stations. This embodiment of the present invention will be described below in detail.

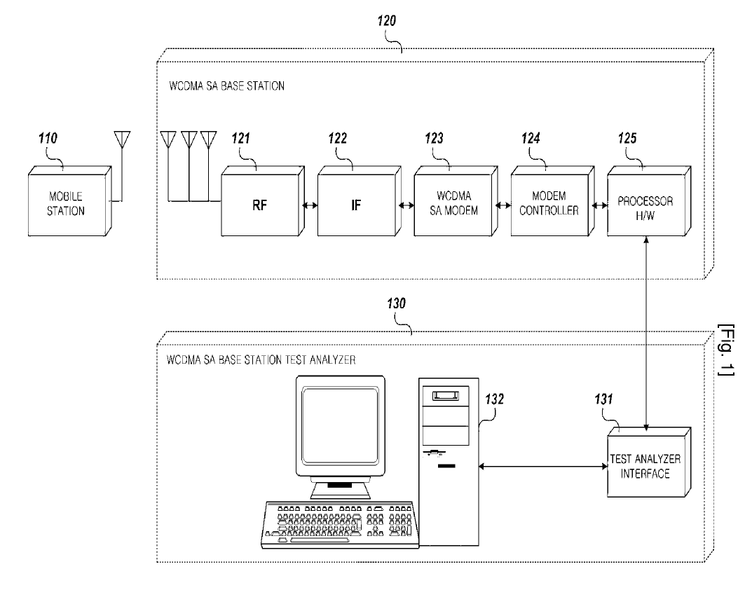

FIG. 1 is a schematic of a WCDMA mobile communication system with an SA according to an embodiment of the present invention, where the WCDMA mobile communication system includes a WCDMA mobile station 110, a base station 120 having a WCDMA SA, and a test analyzer 130 of the base station. Hereinafter, a description will be given as to a process for transmission of a WCMA signal from the mobile station 110 to the base station 120, and the reverse process, i.e., WCDMA signal transmission from the base station 120 to the mobile station 110 will not be described below.

Referring to FIG. 1, the WCDMA mobile station 110, which is a normal mobile station used by an actual subscriber, provides a general function necessary for communication with the base station 120 and transmits a WCDMA-processed signal to the base station 120 via the SA as an RF (Radio Frequency) signal.

The RF signal is converted to an IF (Intermediate Frequency) signal via an RF converter 121 and an IF converter 122 and finally to a BF (Baseband Frequency) signal, and is transmitted to a WCDMA SA modem 123.

The WCDMA SA modem 123 demodulates the signal received from the mobile station 110 and transmits the demodulated information to a modem controller 124.

The modem controller 124 channel-decodes the demodulated information and communicates with a channel processor. The channel processor controls the WCDMA SA modem 123 and the modem controller 124 and transmits/receives the exchanged information to/from a test analyzer body 132. Here, the channel processor comprises processor hardware 125, and a test analyzer interface 131.

The processor hardware 125 is typically implemented with a CPU (Central Processor Unit), and the test analyzer interface 131 executes the functional program of the channel processor.

The test analyzer body 132 has a test call management function including channel establishment/release of the base station 120 in the WCDMA mobile communication system, so the operator can receive various wireless multimedia services by communication with the mobile station through a wireless channel.

The test analyzer body 132 controls the function of each component device in the base station 120, from the RF converter 121 to the processor hardware 125, and manages a statement indicating measurement content, measurement start, and measurement end to each component device for the sake of performance diagnosis of the WCDMA mobile communication system.

Hence, the operator is enabled to test the operational state including the function and the performance of the WCDMA mobile communication system, from the base station 120 to the mobile station 110, in a cell of the base station 120.

The test analyzer body 132 classifies and analyzes the measured data, allowing the operator to test the function and the performance of the SA base station 120. The measured data include, for example, an antenna-specific transmission/reception power of the RF converter 121, an IF-level transmit/receive signal intensity of the IF converter 122, a wireless path-specific signal intensity of the WCDMA SA modem 123, an antenna direction-specific weight, a demodulator estimation signal intensity, a modulator/demodulator state value, a demodulator offset value related to a propagation delay time, and traffic quality information such as a bit error rate of the modem controller 124.

The operational state parameters analyzed from the measured data include, for example, a traffic frame quality, a bit energy-to-noise ratio, an operational performance of the SA base station system including a demodulator, a mobile station location, or the like. These data can be provided along with the mobile communication service in real time and stored in a separate memory for the purpose of use in the future more precise analysis.

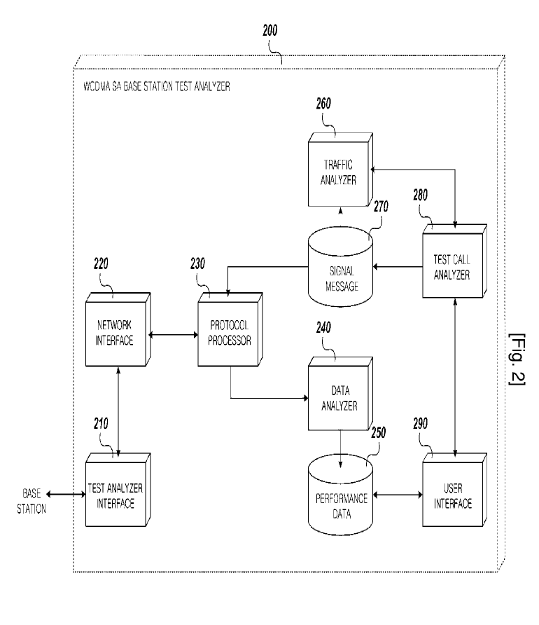

FIG. 2 is a schematic of a test analyzer 200 for testing a base station with an SA according to an embodiment of the present invention. The test analyzer 130 and the test analyzer interface 131 of the WCDMA SA base station of FIG. 1 are the same as a test analyzer 200 and a test analyzer interface 210 of the WCDMA SA base station of FIG. 2, respectively.

Returning to FIG. 1, the test analyzer 130 of the WCDMA SA base station comprises the test analyzer body 132 and the test analyzer interface 131. The test analyzer body 132 of FIG. 1 comprises a network interface 220, a protocol processor 230, data processors 240 and 250, test call processors 260, 270, and 280, and a user interface 290, as shown in FIG. 2. The block-specific function and operation are described as follows.

The data processors include the data analyzer 240 and the performance database 250. The test call processors include the traffic analyzer 260, a signal message database 270, and a test call analyzer 280.

First, the operator causes the user interface 290 to generate a test call. The test call includes various multimedia calls including voice, video, Internet, etc., each of which communicates with the mobile station 110 according to a corresponding protocol.

The test call analyzer 280 selects a protocol corresponding to a test call input by the operator and stores signal messages used for the selected protocol in order in the signal message database 270 via a message generator, i.e., the protocol processor 230. Here, the performance database 250 and the signal message database 270 can be a memory.

To establish a channel to the mobile station 110, the protocol processor 230 communicates with the mobile station 110, the modem controller 124, and the test analyzer interface 131 by the message stored in the signal message database 270 according to a corresponding protocol.

Once the channel to the mobile station 110 is established, this is reported to the network interface 220 and the traffic analyzer 260 for transmission/reception of corresponding traffic to/from the mobile station 110. Here, the network interface 220 serves as a window of the test analyzer body 132 and communicates with the test analyzer interface 210 by TCP-IP to transmit/receive the protocol signal message stored in the signal message database 270 and the traffic and performance data stored in the performance database 250 to/from the base station 120.

The protocol signal message is transmitted to the test call analyzer 280 via the traffic analyzer 260, so that the operator can monitor a call setup procedure. The traffic is analyzed at the traffic analyzer 260, and the analysis results such as frame error rate, propagation delay, etc. are transmitted to the test call analyzer 280, enabling the operator to monitor the traffic quality.

The performance data are processed at the data analyzer 240. The analysis results such as the modulator/demodulator state, the operational performance of the base station, etc. are stored in the performance database 250 and transmitted to the user interface 290 by the request of the operator, so the operator can monitor the performance of the WCDMA mobile communication system.

The protocol communication will be exemplified as follows to describe the specific operations of the test analysis interface 131 and the test analysis body 132 to measure the wireless performance of the WCDMA SA base station of FIG. 1.

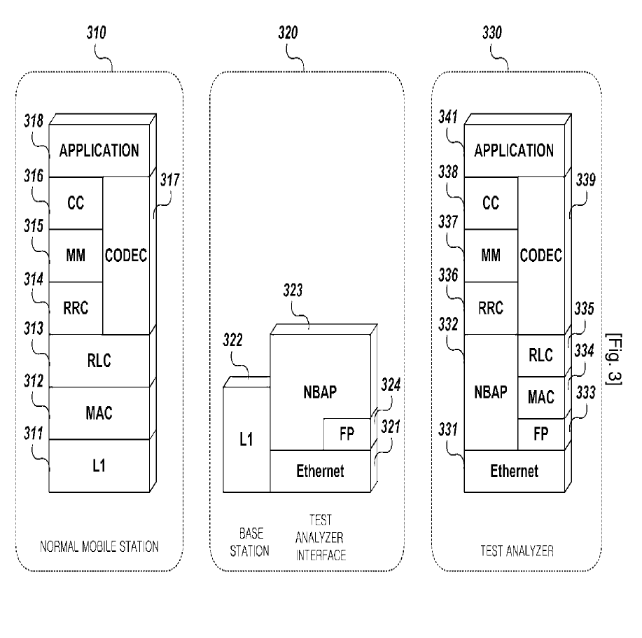

FIG. 3 illustrates a communication protocol structure of a test analyzer for testing a base station with an SA according to an embodiment of the present invention, where the communication protocol structure is constructed among a normal mobile station 310, a WCDMA SA base station, and a test analyzer body 330. Here, the reference numeral 320 denotes a protocol layer of the base station 120 and the test analyzer interface 131 shown in FIG. 1.

Referring to FIG. 3, when the test analyzer body 330 generates a test call, an application layer 341 of the test analyzer body 330 requests a CC (Call Control) service from a CC layer 338 of the test analyzer body 330. Then, the CC layer 338 requests a MM (Mobility Management) service from a MM layer 337 of the test analyzer body 330.

The MM layer 337 requests a RRC (Radio Resource Control) service from a RRC layer 336 of the test analyzer body 330. The RRC layer 336 requests an RLC (Radio Link Control) service from an RLC layer 335 of the test analyzer body 330.

Subsequently, the RLC layer 335 requests a MAC (Medium Access Control) service from a MAC layer 334 of the test analyzer body 330. The MAC layer 334 requests a FP (Frame Protocol) service from a FP layer 333 of the test analyzer body 330. The FP layer 333 requests an Ethernet service from an Ethernet layer 331 of the test analyzer body 330.

The service requests of those layers are transferred to the test analyzer interface, which processes the services from the Ethernet layer 331 and the FP layer 333 but transfers the services from the upper layers, i.e., the application layer 341 and the MAC layer 334 to the base station.

The base station carries the service requests from the application layer 341 or the MAC layer 334 on an L1 (Layer 1) layer 322 and transfers them to the normal mobile station 310. The mobile station 310 processes the services in a reverse direction of the service requests from the layers in the test analyzer body 330.

L1 layer 311 of the normal mobile station 310 reports the service request of application layer 318 or MAC layer 312 to the MAC layer 312 of the normal mobile station 310. The MAC layer 312 of the normal mobile station 310 reports the service request of the application layer 318 or an RLC layer 313 to the RLC layer 313 of the normal mobile station 310. The RLC layer 313 of the normal mobile station 310 reports the service request of the application layer 318 or a RRC layer 314 to the RRC layer 314 of the normal mobile station 310.

In this way, a CC layer 316 of the normal mobile station 310 reports the service request of the application layer 318 to the application layer 318 of the normal mobile station 310. Finally, the call request information generated from the application layer 341 of the test analyzer body 330 is transferred to the application layer 318 of the normal mobile station 310. The message transfer from the normal mobile station 310 to the test analyzer body 330 is performed in the reverse of this process.

The traffic communicated between the test analyzer body 330 and the mobile station 310 are transferred to a codec layer 339 for processing multimedia traffic, rather than the application layer 341 and the RRC layer 336. Therefore, the traffic channel between the test analyzer body 330 and the mobile station 310 is established in the order of application layer 341, RRC layer 335, MAC layer 334, FP layer 333, and Ethernet layer 331 in the test analyzer body 330, Ethernet layer 321 and FP layer 324 in the test analyzer interface, L1 layer 311, MAC layer 312, RRC layer 313, and codec layer 317 in the normal mobile station 310. Using the established traffic channel, the test analyzer body 330 transmits/receives the traffic to/from the normal mobile station 310.

The performance data of the base station are transmitted to the test analyzer body 330 via an NBAP (Node-B Application Protocol) layer 332 of the test analyzer 330.

Consequently, the embodiment of the present invention efficiently performs a series of testing procedures in a single device and effectively tests and analyzes the function and the performance of a base station having a WCDMA smart antenna to provide mass multimedia services to a normal mobile station. In addition, the present invention has a function of directly controlling the test call by service type and monitoring the protocol, as well as a function of collecting and analyzing performance data and a function of providing the analysis results on a graph display, thereby enabling the control of the test call and the monitoring of the performance for a normal mobile station. Hence, the present invention is useful in the aspect of both economy and efficiency in testing the operational state of the base station.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

According to the present invention, the operator can generate mass mobile communication multimedia calls in a simple and convenient way while communicating with a normal mobile station, and effectively diagnose the function and the performance of the system as well as call-specific service quality.

Furthermore, the present invention is applicable to both a system development test and a system operation to allow an economically test and guarantee the function and the performance of the WCDMA mobile communication system, thereby enhancing the competitiveness of the WCDMA mobile communication system.

1. An apparatus for testing and analyzing a base station having a smart antenna, which is for a WCDMA (Wideband Code Division Multiple Access) mobile communication system, the apparatus comprising:
a test analyzer body for performing management of a test call including channel establishment/release of the base station, connecting to the base station to generate mass mobile communication multimedia test calls, and measuring and analyzing an operational state of the system including service-specific functions and performance of the system; and
a test analyzer interface for transmitting/receiving a protocol signal message, traffic, and performance data to/from the test analyzer body.

2. The apparatus as claimed in claim 1, wherein the test analyzer body comprises:
a user interface for generating a test call so as to enable a direct connection to the base station for monitoring the performance of the system;
a test call processor for selecting a protocol corresponding to the test call, analyzing a signal message for the protocol to monitor a call setup procedure, processing the test call to analyze traffic, and monitoring the quality of the traffic according to the analysis result of the traffic;
a protocol processor for generating a signal message used for the selected protocol;
a data processor for analyzing and processing the performance data of the test call processor; and
a network interface for communicating with the test analyzer interface to transmit/receive the protocol signal message, the traffic, and a performance message.

3. The apparatus as claimed in claim 2, wherein the test call processor comprises:
a test call analyzer for selecting a corresponding protocol according to the test call;
a traffic analyzer for reporting the protocol signal message to the test call analyzer to monitor the call setup procedure, or reporting the analysis result of the traffic to the test call analyzer to monitor the quality of the traffic; and
a signal message database for storing the signal message in order.

4. The apparatus as claimed in claim 2, wherein the data processor comprises:
a data analyzer for analyzing the performance data of the test call processor; and
a performance database for storing an analysis result of the data analyzer.

5. The apparatus as claimed in claim 1, wherein the test call includes a voice, video, or Internet multimedia call, the test call communicating with a mobile station according to a corresponding protocol.

6. The apparatus as claimed in claim 2, wherein the protocol processor establishes a channel to a mobile station using a message stored in a signal message database according to the corresponding protocol.

7. The apparatus as claimed in claim 6, wherein when a channel to the mobile station is established, the protocol processor reports the result to the network interface and a traffic analyzer of the test call processor and transmits/receives the corresponding traffic to/from the mobile station.

8. The apparatus as claimed in claim 3, wherein the analysis result of the traffic includes an analysis result of a frame error rate, or a propagation delay.

9. The apparatus as claimed in claim 4, wherein the analysis result of the data processor includes an analysis result of a modulation/demodulation state, or an operational performance of the base station.

10. The apparatus as claimed in claim 4, wherein the data stored in the performance database are reported to the user interface by a request of an operator, enabling the operator to monitor the performance of the mobile communication system.

11. A method for testing and analyzing a base station having a smart antenna, which is for a WCDMA mobile communication system, the method comprising:
(a) generating a test call so as to enable an operator to directly connect to the base station and monitor performance of the system;
(b) selecting a protocol corresponding to a test call input by the operator;
(c) generating a signal message used for the selected protocol;
(d) monitoring a call setup procedure according to the protocol signal message, or processing the test call to analyze traffic; and
(e) testing a function, performance, and an operational state of the base station according to the analysis result of the traffic, and analyzing performance data according to the test result.

12. The method as claimed in claim 11, further comprising:
transmitting the protocol signal message, the traffic, and the performance data.

13. The method as claimed in claim 11, further comprising:
storing the signal message and the performance data in a database.

14. The method as claimed in claim 11, wherein the test call includes a voice, video, or Internet multimedia call, the test call communicating with a mobile station according to a corresponding protocol.

15. The method as claimed in claim 11, wherein an operational state parameter tested in the step (e) is selected from a group consisting of a traffic frame quality, a bit energy-to-noise ratio, an operational performance of the base station system, and a mobile station location.

16. A communication protocol structure of an apparatus for test analysis of a base station, which is a communication protocol structure of an apparatus for test analysis of a base station having a smart antenna in a WCDMA mobile communication system, the communication protocol structure comprising:
(a) an application layer for requesting a call control service to control a test call generated from a test analyzer body;
(b) a call control (CC) layer for performing the call control service and then requesting a mobility management service;
(c) a mobility management (MM) layer for performing the mobility management service and then requesting a radio resource control service;
(d) a radio resource control (RRC) layer for performing the radio resource control service and then requesting a radio link control service;
(e) a radio link control (RLC) layer for performing the radio link control service and then requesting a medium access control service;
(f) a medium access control (MAC) layer for performing the medium access control service and then requesting a frame protocol service;
(g) a frame protocol (FP) layer for performing the frame protocol service and then requesting an Ethernet service; and
(h) an Ethernet layer for transferring a service request of the test analyzer body to a test analyzer interface.

17. The communication protocol structure as claimed in claim 16, further comprising:
a codec layer for processing multimedia traffic.

18. The communication protocol structure as claimed in claim 16, further comprising:
a node-B application protocol (NBAP) layer for transmission of performance data between the test analyzer and the base station.

19. A communication protocol structure of an apparatus for test analysis of a base station, which is a communication protocol structure of an apparatus for test analysis of a base station having a smart antenna in a WCDMA mobile communication system, the communication protocol structure comprising:
(a) an application layer for requesting a call control service to control a test call generated from a test analyzer body;
(b) a call control (CC) layer for performing the call control service and then requesting a mobility management service;
(c) a mobility management (MM) layer for performing the mobility management service and then requesting a radio resource control service;
(d) a radio resource control (RRC) layer for performing the radio resource control service and then requesting a radio link control service;
(e) a radio link control (RLC) layer for performing the radio link control service and then requesting a medium access control service;
(f) a medium access control (MAC) layer for performing the medium access control service and then requesting a frame protocol service;
(g) a frame protocol (FP) layer for performing the frame protocol service and then requesting an Ethernet service; and
(h) an Ethernet layer for transferring a service request of the test analyzer body to a test analyzer interface,
wherein the test analyzer interface processes services of the Ethernet layer and the frame protocol layer and transfers service requests of the application layer and the medium access control layer.

20. A method for using a communication protocol among a mobile station, a base station, and a test analyzer, which is in a WCDMA mobile communication system, the method comprising:
(a) transferring service requests from a plurality of protocol layers of a test analyzer body;
(b) processing services of an Ethernet layer and a frame protocol layer among the plural protocol layers, and transferring service requests of an application layer or a medium access control layer;
(c) carrying the service requests of the application layer or the medium access control layer transferred to the base station on an L1 (Layer 1) layer and transferring the carried service quests to the normal mobile station; and
(d) processing the service from the normal mobile station in a reverse direction of processing the service requests among the layers of the test analyzer body.

21. The method as claimed in claim 20, wherein traffic communication between the test analyzer body and the normal mobile station is achieved through a codec layer for processing multimedia traffic.

22. The method as claimed in claim 20, wherein performance data transferred between the test analyzer body and the base station are transmitted to the test analyzer body via an NBAP layer.
